(19) United States
(12) Patent Application Publication
(10) Pub. No.: US 2007/0063515 A1
(43) Pub. Date: Mar. 22, 2007

(54) Piloted companion flange joint

(76) Inventors: Paul H. Mackiewicz, Royal Oak, MI (US); Anthony R. Burg, Macomb Township, MI (US); Robert A. Benson, Bloomfield Hills, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/230,351

(22) Filed: Sep. 19, 2005

(51) Int. Cl. F16L 23/00

(52) U.S. Cl. 285/368

(57) ABSTRACT

A flange joint includes opposed companion flanges including opposed faces having central voids therein, and mutually engageable teeth. A pilot member is carried by one of the companion flanges in its central void and is arranged for insertion into the central void of the other of the companion flanges upon assembly of the companion flanges for preliminary axial and rotational alignment of the flanges before engagement of the mutually engageable teeth.

### FIELD OF THE INVENTION

The present invention relates generally to torque transmitting joints, and more particularly to a serrated companion flange joint.

### BACKGROUND OF THE INVENTION

Companion flange joints are widely used for connecting power transmission shafts. Typical companion flanges have hub ends attached to power transmission shafts, and flange ends with fastener passages that are spaced-apart circumferentially and extend axially through the flanges. A standard companion flange joint includes opposed companion flanges that have flange faces that axially abut one another and are rotationally oriented such that the axial fastener passages of each of the companion flanges are aligned. Fasteners are assembled through the axial fastener passages to clamp the companion flanges together and secure the joint so that torque loads may be transmitted through the joint.

Increasingly, however, serrated companion flange joints are replacing traditional companion flange joints. For example, a cross-tooth companion flange joint is a type of form-locking joint that integrally carries torque loads therethrough. More specifically, a cross-tooth companion flange joint includes opposed cross-tooth companion flanges that have corresponding serrated faces with interlocking teeth that convey torque loads through the joint. Axial fasteners of a cross-tooth companion flange joint are used, but do not carry torque loads and instead carry relatively low resultant tensile forces through the joint to keep the companion flange faces clamped together. Accordingly, use of cross-tooth companion flange joints avoids the need to increase the size of flanges or axial fasteners used in a traditional companion flange joint. In other words, for carrying a given torque load, a relatively smaller cross-tooth companion flange joint replaces a relatively larger traditional companion flange joint.

But cross-tooth companion flange joints can be difficult to assemble. For example, in assembly of a driveshaft to an axle, a driveshaft flange cannot be assembled to a corresponding axle flange in any random rotational position. Rather, the opposed flanges must be brought together in a correct axial and rotational relationship with respect to one another by adjusting the distance between the flanges and by rotating the flanges relative to one other. During this process, an operator generally assists in manually supporting and steadying a relatively long and heavy driveshaft while aligning the driveshaft flange to the axle flange, or vice versa. In this type of situation, the operator potentially has to repeat this process several hundred times per day, which may lead to operator fatigue and slowdowns in production throughput.

### SUMMARY OF THE INVENTION

A piloted companion flange joint includes opposed companion flanges including opposed faces arranged for abutment with one another. The opposed faces have central voids, fastener passages therethrough, and mutually engageable teeth. A pilot member is carried by one of the companion flanges in its central void and is arranged for insertion into the central void of the other of the companion flanges upon assembly of the companion flanges for preliminary axial and rotational alignment therebetween before engagement of the mutually engageable teeth.

In one presently preferred implementation, the pilot member is press fit into one of the central voids and fits freely within the other of the central voids. Moreover, the length of the pilot member is greater than the root-to-tip height of the mutually engageable teeth to ensure that the companion flanges can rotate relatively freely when the pilot member is received in the cavity at both flanges but before the teeth mutually engage during assembly of the joint.

### BRIEF DESCRIPTION OF THE DRAWINGS

These and other objects, features and advantages of the present invention will be apparent from the following detailed description of the preferred embodiments and best mode, appended claims and accompanying drawings in which:

FIG. 1 is a partially exploded cross-sectional view of one embodiment of a piloted companion flange joint;

FIG. 2 is an end view of a companion flange of the joint of FIG. 1; and

FIG. 3 is an enlarged fragmentary view of a portion of the joint of FIG. 1 when assembled.

### DETAILED DESCRIPTION OF PREFERRED EMBODIMENTS

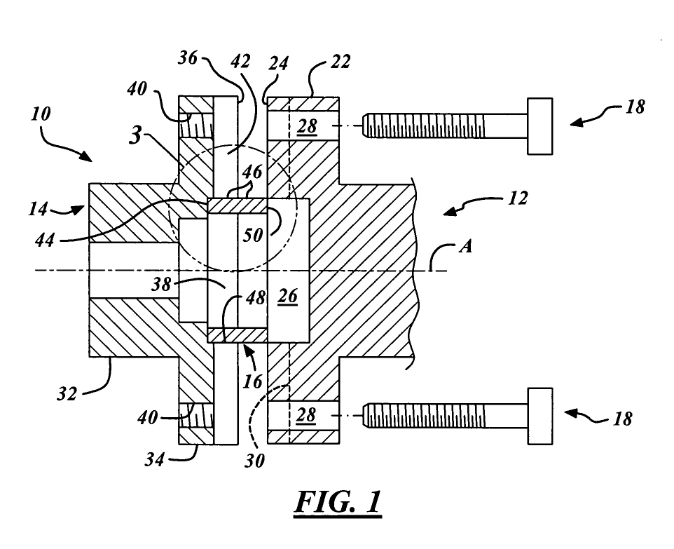

Referring in more detail to the drawings, FIG. 1 illustrates a partially exploded cross-sectional view of a piloted companion flange joint 10 for coupling shafts together for power transmission. Those of ordinary skill in the art will recognize that the joint 10 may be used in rigid or flexible coupling implementations and may be used in any of a wide variety of arrangements including, but not limited to, vehicle driveshafts to axles or transfer cases, driveshafts to driveshafts, electric motors to driveshafts, and the like.

The joint 10 includes a first coupling member or companion flange 12 arranged for piloted engagement with a second coupling member or companion flange 14 by way of a pilot member 16 such as a cylinder, sleeve, ring, dowel, disk, or the like. The companion flanges 12, 14 are also arranged for fastening by a plurality of fasteners 18 such as bolts. The companion flanges 12, 14 may be designed consistent with “T-Type Flanges” according to SAE Surface Vehicle Standard J1945, or ISO standard 12667, or may be customized.

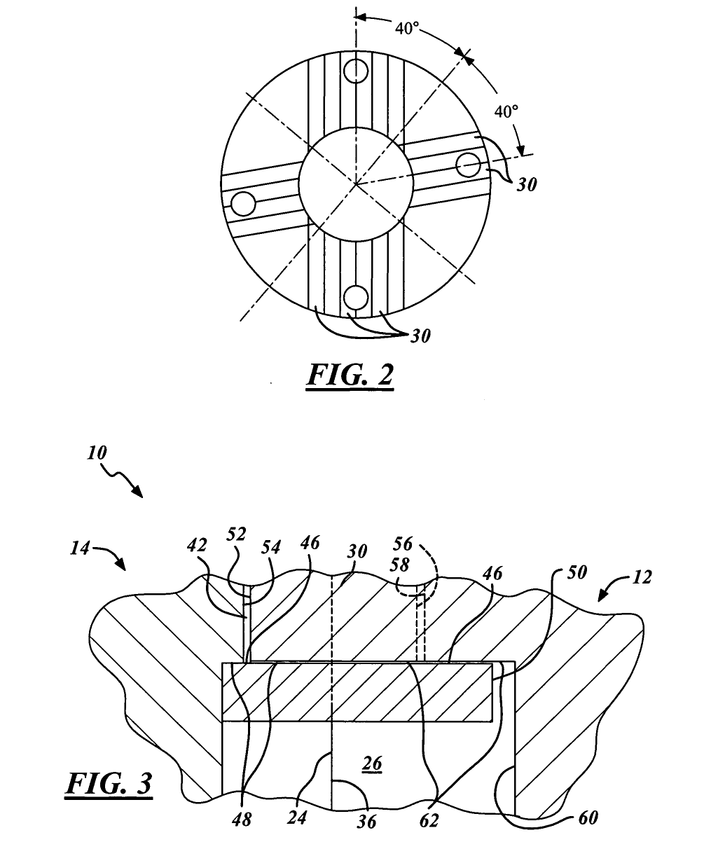

As shown in FIGS. 1 and 2, the first companion flange 12 includes a hub 20 and a flange 22 extending radially outwardly from one end of the hub 20. The flange 22 has a face 24 with a central void 26 therein. The void 26 may be a blind pocket, as shown, or may be a through passage that extends axially or otherwise in or through the companion flange 12. The flange 22 also has a plurality of fastener passages 28 extending axially therethrough and, as best shown in FIG. 2, a first plurality of serrations defining teeth 30 therein. The serrations and teeth 30 are provided in an intersecting pattern disposed at an angle on either side of a reference line bisecting the teeth 30. Hence, the teeth 30 as shown are called cross-teeth and may be disposed at a forty-degree angle as shown, or ninety degrees, or any other suitable angle desired. However, it is contemplated that any number of serrations could also be provided and in any other orientation. For example, the serrations and teeth could be provided in a radial orientation with respect to the center of the flange. In other words, radial serrations, instead of cross-cut serrations could be used with the companion flanges 12, 14.

Referring to FIG. 1, the second companion flange 14 includes a hub 32 and a flange 34 extending radially outwardly from one end of the hub 32. The flange 34 has a face 36 with a central void 38 therein. The void 38 may be a through passage, as shown, that extends axially or otherwise in or through the companion flange 14, or may be a blind pocket. The flange 14 also has a plurality of fastener passages 40 extending axially therethrough and a plurality of serrations or cross-teeth 42 therein that correspond, or are complementary, to the cross-teeth 30 of the first companion flange 12. Again, any number and type of orientation of serrations may be provided.

Although the companion flanges 12, 14 are shown as substantially cylindrical coupling members with cylindrical hubs 20, 32, the companion flanges may also be yoke-type coupling members with forked hubs, integral ends of shafts, or the like. The companion flanges 12, 14 may be constructed in any suitable fashion and may be composed of any desired material such as iron, steel, or any other suitable metal, and the voids 26, 38, fastener passages 28, 40, and cross-teeth 30, 42 may be machined, formed, cast, or otherwise manufactured into the respective companion flanges 12, 14. The flange faces 24, 36 preferably are flat such that the cross-teeth 30, 42 are produced in a planar surface. The cross-teeth 42 preferably are produced in the respective companion flange 14 before the pilot member 16 is assembled into it.

Referring to FIG. 1, the pilot member 16 is carried by the second companion flange 14 and, preferably, is fixed thereto. More specifically, it is preferred that a fixed end 44 of the pilot member 16 is press fit into the central void 38 wherein an outer diameter 46 of the pilot member 16 is somewhat larger than a corresponding inner diameter 48 of the central void 38. Alternatively, however, those of ordinary skill in the art will recognize that the pilot member 16 could be positively retained or interlocked, axially and/or radially, with respect to the companion flange 14 such as by use of a separate snap ring, integral threads, locator pin, or the like (not shown). In any case, the pilot member 16 is arranged for insertion into the first central void 26 of the first companion flange 12 upon assembly of the companion flanges 12, 14 for preliminary axial and rotational alignment therebetween before the cross-teeth 30, 42 mutually engage, intermesh, or interengage. The pilot member 16 may be manufactured in any suitable manner including forming, casting, forging, machining, molding, or the like and may be composed of any suitable material, such as iron, steel, or any other suitable metal, or any suitable polymeric or composite materials capable of piloting the companion flange joint 10 during assembly thereof.

In assembly, and referring to FIGS. 1 through 3, the companion flanges 12, 14 are moved relatively toward one another in an axial direction along a shared operational axis A, such that the faces 24, 36 of the flanges 22, 24 are brought toward one another with a goal of centering and inserting the free end 50 of the pilot member 16 into the central void 26 of the first companion flange 12. At this point, the companion flanges 12, 14 may be moved toward one another with or without respect to circumferential or rotational alignment of the corresponding fastener passages 28, 40. Once the companion flanges 12, 14 have been moved toward one another to such an extent that the free end 50 of the pilot member 16 has been inserted at least a short distance into the central void 26 of the first companion flange 12, then one or both of the companion flanges 12, 14 (and any associated power transmission shafts) may be rotatably oriented relative to one another so as to rotationally or circumferentially align the fastener passages 28, 40. Note that the pilot member 16 may carry the weight of the shaft 20 to facilitate assembly. Once the fastener passages 28, 40 have been so aligned, the opposed faces 24, 36 of the companion flanges 12, 14 may be brought together in face-to-face contact or abutment such that the corresponding cross-teeth 30, 42 of the flanges 22, 34 interlock or mutually engage, as shown in FIG. 3. Thereafter, the fasteners 18 may be assembled through the axial fastener passages 28, 40 to clamp the companion flanges 12, 14 and secure the joint 10.

As shown in solid lines in FIG. 3, when the flanges 12, 14 are fully assembled together, a tip 52 of one tooth of the first companion flange 12 is disposed adjacent a root 54 of one tooth of the second companion flange 14 with a slight axial gap therebetween. Likewise, and as shown in hidden lines, a tip 56 of another tooth of the second companion flange 14 is disposed adjacent a root 58 of another tooth of the first companion flange 12 with a slight axial gap therebetween. In other words, the complementary or corresponding teeth of the flanges 12, 14 are circumferentially interengaged to carry torque in opposed rotational directions.

Moreover, there is axial clearance between the free end 50 of the pilot member 16 and a bottom surface 60 of the central void 26 of the first companion flange 12 to avoid axial assembly interference. Likewise, there is radial clearance between the outer diameter 46 of the pilot member 16 and an inner diameter 62 of the first companion flange 12 within the central void 26 to allow the pilot member 16 to fit freely within the first companion flange 12. Also, the length of the pilot member 16 preferably exceeds the root-to-tip height of the mutually engageable teeth 30, 42 to ensure that the companion flanges 12, 14 rotate relatively freely and the weight of the components are supported before the cross-teeth 30, 42 mutually engage. More specifically, the length of the portion of the pilot member 16 that extends beyond the face 36 of the companion flange 14 preferably exceeds the root-to-tip height of the mutually engageable teeth 30, 42.

Thus, the piloted companion flange joint 10 is a form-locking joint that is capable of integrally carrying torque loads therethrough. More specifically, the piloted companion flange joint 10 includes the opposed serrated companion flanges 12, 14 with their opposed corresponding serrated faces 24, 36 having the interlocking pluralities of cross-teeth 30, 42 to convey torque loads through the joint 10 for power transmission from one machine to another, such as from a vehicle transmission to a vehicle axle, or any other suitable configurations. The axial fasteners 18 preferably do not carry any significant torque loads and instead carry relatively low resultant tensile forces through the joint 10 to keep the companion flange faces 24, 36 clamped together. Advantageously, however, the pilot member 16 enables the piloted companion flange joint 10 to be relatively easily assembled to avoid operator fatigue and increase production throughput.

While certain preferred embodiments have been shown and described, persons of ordinary skill in this art will readily recognize that the preceding description has been set forth in terms of description rather than limitation, and that various modifications and substitutions can be made without departing from the spirit and scope of the invention. By way of example without limitation, while the companion flange joint has been shown as being a vehicular coupling, it could be otherwise be suited for use with any type of power transmission applications. Of course, still other modifications and substitutions can be made. The invention is defined by the following claims.

What is claimed is:

1. A flange joint, comprising:
opposed companion flanges including opposed faces having central voids therein, and mutually engageable teeth; and
a pilot member carried by one of the companion flanges in its central void and arranged for insertion into the central void of the other companion flange upon assembly of the companion flanges for preliminary axial and rotational alignment of the flanges before engagement of the mutually engageable teeth.

2. The flange joint of claim 1 which also comprises:
fastener passages in the flanges; and
a plurality of fasteners extending through the fastener passages to clamp the companion flanges together.

3. The flange joint of claim 1 wherein the pilot member is fixed to the one companion flange in the central void thereof and fits freely within the other central void.

4. The flange joint of claim 1 wherein the pilot member is press-fit into the one central void of the one companion flange.

5. The flange joint of claim 1 wherein the length of a portion of the pilot member is greater than a root-to-tip height of the mutually engageable teeth.

6. A piloted companion flange joint, comprising:
a first companion flange having an axis of rotation and including a first face with a first central void therein, a first plurality of fastener passages extending therethrough, and a first plurality of axially extending teeth therein;
a second companion flange having an axis of rotation and including a second face arranged for abutment with the first face of the first companion flange, the second face having a second central void therein, a second plurality of fastener passages extending therethrough, and a second plurality of axially extending teeth therein arranged to be intermeshed with the first plurality of teeth; and
a pilot member carried by the second companion flange in its second central void and arranged for insertion into the first central void of the first companion flange upon assembly of the second companion flange and the first companion flange for preliminary axial and rotational alignment therebetween before the pluralities of teeth are intermeshed.

7. The piloted companion flange joint of claim 5 further comprising:
a plurality of fasteners extending through the pluralities of fastener passages to clamp the first and second companion flanges together.

8. The piloted companion flange joint of claim 5 wherein the pilot member is press fit into the second central void and fits freely within the first central void.

9. The piloted companion flange joint of claim 5 wherein the length of the pilot member is greater than a root-to-tip height of the first and second pluralities of teeth.

10. A companion flange of a piloted companion flange joint including a first companion flange having a first face with a first central void and a first plurality of fastener passages therein, the companion flange comprising:
a face with a central void therein, a plurality of fastener passages extending therethrough, and a plurality of teeth therein; and
a pilot member carried by the companion flange in its central void and arranged for insertion into the first central void of the first companion flange upon assembly of the companion flanges for preliminary axial and rotational alignment therebetween.

11. The companion flange of claim 9 wherein the pilot member is press fit into the central void.
